(19) United States
(12) Patent Application Publication
(10) Pub. No.: US 2006/0187931 A1
(43) Pub. Date: Aug. 24, 2006

(54) Communication system and method for providing information on interface connecting network components

(76) Inventor: Chul-Hoon Hwang, Hwaseong-si (KR)

Correspondence Address: Robert E. Bushnell;Suite 300, 1522 K Street, N.W., Washington, DC, 20005-1202, US

(21) Appl. No.: 11/330,230

(22) Filed: Jan. 12, 2006

(30) Foreign Application Priority Data
Feb. 24, 2005 (KR) 2005-15565

(51) Int. Cl. H04L 12/56

(52) U.S. Cl. 370/392; 370/401

(57) ABSTRACT

A communication system for providing information on an interface connecting network components comprises: a plurality of user agents for collecting the interface information on the respective network components which form the communication system; a terminal for outputting the interface information on the respective network components in response to a user's request; and a call manager for receiving the interface information on the network components from the user agents through a session initiation protocol (SIP), and providing the terminal with the interface information in real time. A method of providing interface information on the network components comprises steps corresponding to the above-listed functions. Thus, the interface status and information can be exchanged between the network components using the same SIP protocol, and a disabled interface can be dealt with faster.

### CLAIM OF PRIORITY

This application makes reference to, incorporates the same herein, and claims all benefits accruing under 35 U.S.C. § 119 from an application for COMMUNICATION SYSTEM AND METHOD FOR PROVIDING INFORMATION ON INTERFACE CONNECTING NETWORK COMPONENTS earlier filed in the Korean Intellectual Property Office on Feb. 24, 2005 and there duly assigned Serial No. 2005-15565.

### BACKGROUND OF THE INVENTION

1. Technical Field

The present invention relates to a communication system and method for providing information on an interface connecting network components and, more particularly, to a communication system and method using a presence function to provide information on an interface connecting network components.

2. Related Art

Session initiation protocol (SIP) is a signaling protocol for generating, correcting and finishing an Internet-based multimedia service session. In particular, SIP is used as a protocol at the application level for signaling in voice over Internet protocol (VoIP). SIP is used in setting a multimedia session in VoIP, and includes a client and a server. The client is classified as a user-agent client (UAC) or a user-agent server (UAS) according to whether it sends or receives a call session connection request. A client which sends a session connection request is called a UAC, and a client which receives a session connection request is called a UAS. The server includes a proxy server, a redirect server, and a registrar server, which differ in operational method.

A communication system for an SIP communication network includes an SIP UAC, SIP redirect servers, SIP registrar servers, SIP proxy servers, a SIP presence server, and a SIP UAS.

The SIP UAC is an application program of a caller, and has the function of requesting a call, and the SIP UAS is an application program of a receiver, and has the function of allowing, redirecting, or rejecting a call requested by the SIP UAC.

The SIP proxy server operates as a router of an application layer for forwarding an SIP request/response. The SIP proxy server forwards an SIP request from the SIP UAC to the SIP UAS through the SIP proxy server, and the SIP proxy server forwards an SIP response of the SIP UAS to the SIP request to the SIP UAC through the SIP proxy server.

If an SIP request from a client (SIP UAC or SIP UAS) is received, the SIP redirect servers inform the client of the location of another SIP server or a user agent (UA) where another client, to which the SIP request is to be forwarded, is located.

The SIP registrar servers track the location of a client to which the SIP request is to be forwarded in response to a request from the SIP proxy servers.

The SIP presence server stores subscribers' presence information (e.g., communication means, communication willingness, communication capability and characteristics, etc.), and enables subscribers to exchange the presence information.

If the SIP is employed in a communication system, it is possible to configure an expandable communication system using a plurality of proxy servers and redirect servers. The SIP provides user mobility as a result of the configuration described above. That is, the communication system tracks the present location of a user using the SIP registrar servers, and registers the location information with the location server. If the SIP proxy server receives a call request, it forwards the call request to the location of the user by referring to the location information. If the redirect server receives a call request, it responds with the present location of a corresponding user with reference to the location information.

Due to the configuration described above, the redirect servers have the advantage of dispersing system load, and the proxy servers provide reliability resulting from flexibility and replication, and expandability resulting from partition when a communication network service is implemented.

If the communication system is implemented in a VoIP-based network, the SIP UAC and the SIP UAS may be an SIP phone or an analog phone, or a gateway or a VoIP router. It is possible to implement the communication system by integrating various SIP server functions (e.g., those of a registrar module, a redirect mode, a SIP proxy module, etc.) for a VoIP call process, and by using a call manager which performs a supplemental call service, a subscriber process, etc. That is, the communication system is implemented such that the call manager provides a service while interworking with a gateway/VoIP router device which provides a media processing service in the communication system.

Routers, including an SIP UA, analog phones, and SIP phones, operate either an SIP UAC or an SIP UAS.

A call manager includes process modules (e.g., a registrar module, a redirect module, and an SIP proxy module), each corresponding to the SIP registrar servers, the SIP redirect servers, and the SIP proxy servers, and a call controller which has the function of controlling operations of the process modules and a call process function. Also, the call manager provides various integrated services, such as subscriber admission, supplemental services, a VMS function, a UMS function, an interactive voice response (IVR) function, and an interface function. The call manager interworks with a presence server to provide a presence service to the analog phones or the SIP phones.

The presence service is one which receives and stores subscribers' presence information, and forwards corresponding presence information when there is a presence information request from a user who is registered as a buddy. The presence information indicates communication availability, and includes a communication means for users who are registered as buddies, communication willingness, and communication capability and characteristics. Communication means includes instant messaging, VoIP, mobile phone, e-mail, game, etc. Communication willingness includes, for example, e-mail transmission for urgency, all conversation denial, etc. Communication capability and characteristics include voice mail support, voice or video support, mobile or fixed, various language support, etc.

The object which requests the presence information is called a subscriber, and the object which is requested by the subscriber to provide the presence information is called a presentity. A subscriber who is registered as a friend serves as the presentity of the other party.

As a representative example of the presence service, there is friend status information of a messenger service. The messenger service has the function of indicating, to a first subscriber, status information (e.g., online, busy, on the phone, away, etc.) of other subscribers who are registered as friends of the first subscriber.

The presence server provides an SIP phone with the presence information of the SIP phone in response to a request from the SIP phone in the communication system. In this regard, the SIP phone is a subscriber, and the SIP phone serves as the presentity which provides the SIP phone with the presence information.

The SIP phone registers with the presence server (e.g., logs in), and then requests the presence information from the presence server in order to obtain status information of the SIP phone. The presence server which receives and stores the presence information from the SIP phone performs authentication in response to the presence information request. The presence server provides the presence information of the SIP phone to the SIP phone if the presence information request is approved.

Storage of the presence information of the SIP phone in the presence server is performed in such a way that the SIP phone forwards its presence information to the presence server regardless of whether or not the SIP phone requests it.

An Internet engineering task force (IETF) SIP for instant messaging and presence leveraging extensions (SIMPLE) working group (WG) usually uses a SUBSCRIBE method, a NOTIFY method, and a PUBLISH method, which were produced in 2001, and which are defined in RFC3265, in order to provide instant messaging and presence service models defined by the instant messaging and presence protocol working group (IMPPWG) through SIP which is being used in various fields. The SUBSCRIBE method is used by one subscriber to request online accessibility information of another subscriber (presentity), the NOTIFY method is used by the presence system to inform the subscriber to SUBSCRIBE of online status information of the presentity, and the PUBLISH method is used to publish the presence information to a presence agent.

Thus, the registration step of the SIP phone uses the SUBSCRIBE method, the step of forwarding the presence information of the SIP phone uses the PUBLISH method, and the presence information providing step of the presence server uses the NOTIFY method.

However, the SIP presence technology described above has not yet been applied to network operation and management.

For example, in a communication system, the call manager and the routers may require supplemental information (e.g., interface information) in addition to information for call processing. In this case, another information transmitting method, rather than the SIP protocol for call processing, should be used. That is, the SIP protocol cannot be used to transmit supplemental information between network components of the communication system, and thus a separate protocol for transmitting the supplemental information is needed.

### SUMMARY OF THE INVENTION

It is, therefore, an object of the present invention to provide a communication system and method for transmitting supplemental information between network components of the communication system using an SIP protocol.

It is another object to provide a communication system and method for providing information on interface connecting network components using an SIP presence function.

According to an aspect of the present invention, there is provided a communication system which comprises: a plurality of user agents for collecting interface information of respective network components which form the communication system; and a call manager, including a presence module, for providing online access status and location information of a service user, the call manager receiving the interface information of the network components from the user agents through a session initiation protocol (SIP).

The communication system may further include a terminal for outputting the interface information of the network components in response to a user's request, wherein the call manager transmits the interface information to the terminal in real time.

Information exchange among the user agent, the terminal and the call manager may be performed using at least one of a SUBSCRIBE method and a NOTIFY method, which are defined in RFC3265, and a PUBLISH method defined in RFC3903.

The terminal may transmit a request to the call manager for the interface information of a certain network component using the SUBSCRIBE method.

The terminal may include a user interface module for outputting the interface information transmitted in response to an interface information request.

The call manager may provide the terminal with the interface information of the certain network component using the NOTIFY method.

When any part of the interface information of the network components transmitted to the user agent contains an obstacle, a corresponding interface which generated the obstacle may be circumvented, and connection may be performed between network components with no obstacles. For example, in the case of a telephone call, the respective interfaces are always connected, and the service is usually provided through a wide area network (Internet protocol) or WAN (IP), and if a connection obstacle occurs, the WAN is circumvented or detoured around, and a call is connected through the public switched telephone network (PSTN).

The user agent may provide the presence module with the interface information of the corresponding network component using the PUBLISH method.

The interface information may have a status field for storing status information according to the type of corresponding interface, and an address field for storing address information of the corresponding interface.

According to another aspect of the present invention, there is provided a method of providing information on interface connecting network components in a communication system, including the steps of: collecting, by means of agent modules corresponding to a plurality of network components, interface information of the corresponding network components; converting the interface information into a predetermined format; and transmitting, by means of each of the agent modules, the interface information converted into the predetermined format to a call manager using a session initiation protocol (SIP).

The method may further include the steps of: storing, by means of the call manager, the interface information; and providing, by means of the call manager, corresponding interface information in response to an interface information request.

The method may further include the steps of, when any of the collected interface information contains an obstacle, circumventing or detouring around a corresponding interface that generated the obstacle, and connecting an interface such that network components are connected with no obstacle.

The method may further include the step of performing, by means of the call manager, authentication of the interface information request in response to the interface information request.

The step of transmitting the interface information may be performed using the PUBLISH method defined in RFC3903. The interface information request may be performed using the SUBSCRIBE method defined in RFC3265. The step of providing the interface information may be performed using the NOTIFY method defined in RFC3265.

The interface information may include a status field for storing status information according to the type of corresponding interface, and an address field for storing address information of the corresponding interface.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings, in which like reference symbols indicate the same or similar components, wherein:

FIG. 1 is a diagram of a communication system for a session initiation protocol (SIP) communication network;

FIG. 2 is a diagram of a communication system for an SIP communication network;

FIG. 3 is a diagram of a presence service providing method;

FIG. 4 is a block diagram of a communication system according to an embodiment of the present invention;

FIGS. 5A and 5B show an example of interface information according to the present invention;

FIG. 6 shows PDIF format information in a PUBLISH method for forwarding the interface information according to an embodiment of the present invention; and

FIG. 7 is a diagram of an interface information providing method according to an embodiment of the present invention.

### DETAILED DESCRIPTION OF THE INVENTION

The present invention will now be described more fully with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

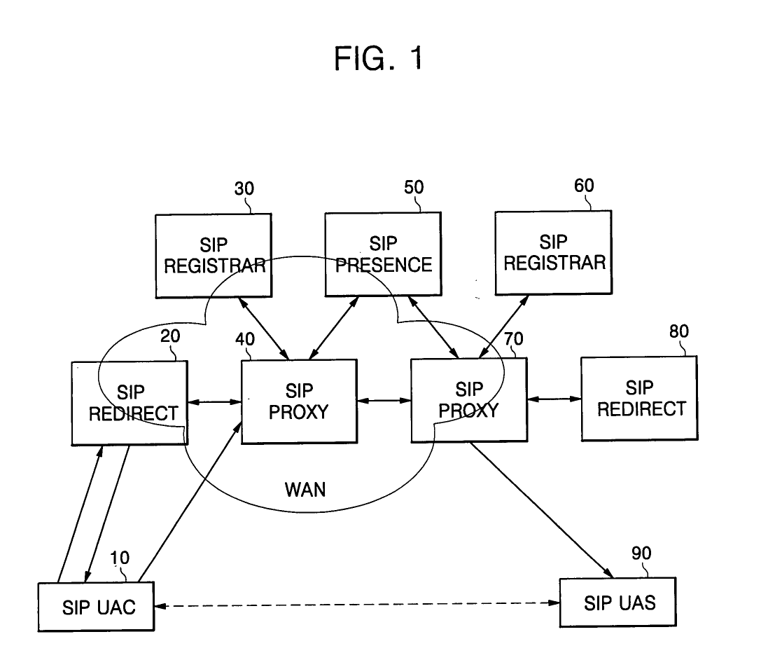

FIG. 1 is a diagram of a communication system for a session initiation protocol (SIP) communication network. Referring to FIG. 1, the communication system for the SIP communication network includes an SIP UAC 10, SIP redirect servers 20 and 80, SIP registrar servers 30 and 60, SIP proxy servers 40 and 70, an SIP presence server 50, and an SIP UAS 90.

The SIP UAC 10 is an application program of a caller, and has the function of requesting a call, and the SIP UAS 90 is an application program of a receiver, and has the function of allowing, redirecting or rejecting a call requested by the SIP UAC 10.

The SIP proxy servers 40 and 70 operate as routers of an application layer for forwarding an SIP request/response. The SIP proxy server 40 forwards an SIP request from the SIP UAC 10 to the SIP UAS 90 through the SIP proxy server 70, and the SIP proxy server 70 forwards an SIP response of the SIP UAS 90 to the SIP request to the SIP UAC 10 through the SIP proxy server 40.

If an SIP request from a client (SIP UAC 10 or SIP UAS 90) is received, the SIP redirect servers 20 and 80 inform the client of the location of another SIP server or a user agent (UA) where another client, to which the SIP request is to be forwarded, is located.

The SIP registrar servers 30 and 60 track the location of a client to which the SIP request is to be forwarded in response to the request from the SIP proxy servers 40 and 70.

The SIP presence server 50 stores subscribers' presence information (e.g., communication means, communication willingness, communication capability and characteristics, etc.), and enables subscribers to exchange the presence information.

As shown in FIG. 1, if the SIP is employed in the communication system, it is possible to configure an expandable communication system using a plurality of proxy servers 40, 70 and redirect servers 20, 80. The SIP provides user mobility as a result of the configuration described above. That is, the communication system of FIG. 1 tracks the present location of a user using the SIP registrar servers 30 and 60, and registers the location information with the location server. If the SIP proxy server 40 or 70 receives a call request, it forwards the call request to the location of the user by referring to the location information. If the redirect server 20 or 80 receives a call request, it responds with the present location of a corresponding user with reference to the location information.

Due to the configuration described above, the redirect servers 20 and 80 have the advantage of dispersing system load, and the proxy servers 40 and 70 provide reliability resulting from flexibility and replication, and expandability resulting from partition when a communication network service is implemented.

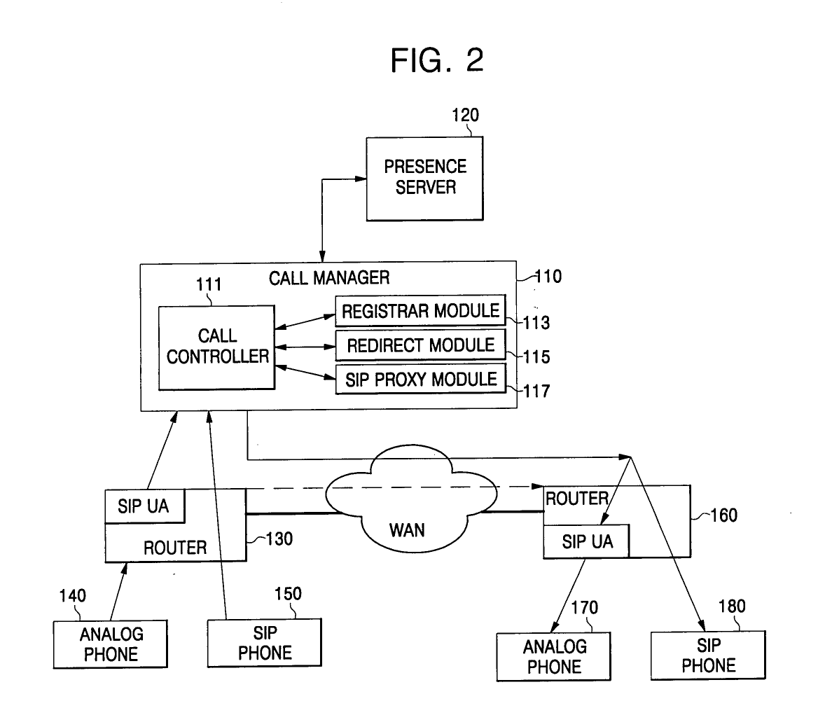

If the communication system is implemented in a VoIP-based network, the SIP UAC 10 and the SIP UAS 90 may be an SIP phone or an analog phone, or a gateway or a VoIP router. It is possible to implement the communication system by integrating various SIP server functions (e.g., a registrar module, a redirect mode, an SIP proxy module, etc.) for a VoIP call process, and by using a call manager which performs a supplemental call service, a subscriber process, etc. That is, the communication system is implemented such that the call manager provides a service while interworking with a gateway/VoIP router device which provides a media processing service in the communication system. A communication system of the type described above is shown in FIG. 2.

FIG. 2 is a diagram of a communication system for an SIP communication network. Referring to FIGS. 1 and 2, routers 130 and 160 including an SIP UA, analog phones 140 and 170, and SIP phones 150 and 180 operate as either the SIP UAC 10 or the SIP UAS 90 of FIG. 1, respectively.

The call manager 110 of FIG. 2 includes process modules (e.g., a registrar module 113, a redirect module 115, and an SIP proxy module 117), each corresponding to the SIP registrar servers 30 and 60, the SIP redirect servers 20 and 80, and the SIP proxy servers 40 and 70 of FIG. 1, and a call controller 111 which has the function of controlling operations of the process modules and a call process function. Also, the call manager 110 provides various integrated services, such as subscriber admission, supplemental services, a VMS function, a UMS function, an interactive voice response (IVR) function, and an interface function. The call manager 110 interworks with a presence server 120 to provide a presence service to the analog phones 140 and 170 or the SIP phones 150 and 180.

The presence service is one which receives and stores subscribers' presence information, and forwards corresponding presence information when there is a presence information request from a user who is registered as a buddy. The presence information indicates communication availability, and includes a communication means of users who are registered as buddies, communication willingness, and communication capability and characteristics. Communication means includes instant messaging, VoIP, mobile phone, e-mail, game, etc. Communication willingness includes, for example, e-mail transmission for urgency, all conversation denial, etc. Communication capability and characteristics include voice mail support, voice or video support, mobile or fixed, various language support, etc.

The object that requests the presence information is called a subscriber, and the object that is requested by the subscriber to provide the presence information is called a presentity. Subscribers who are registered as friends serve as the presentity of the other party.

As a representative example of the presence service, there is friend status information of a messenger service. The messenger service has the function of indicating, to a first subscriber, status information (e.g., online, busy, on the phone, away, etc.) of other subscribers who are registered as friends of the first subscriber.

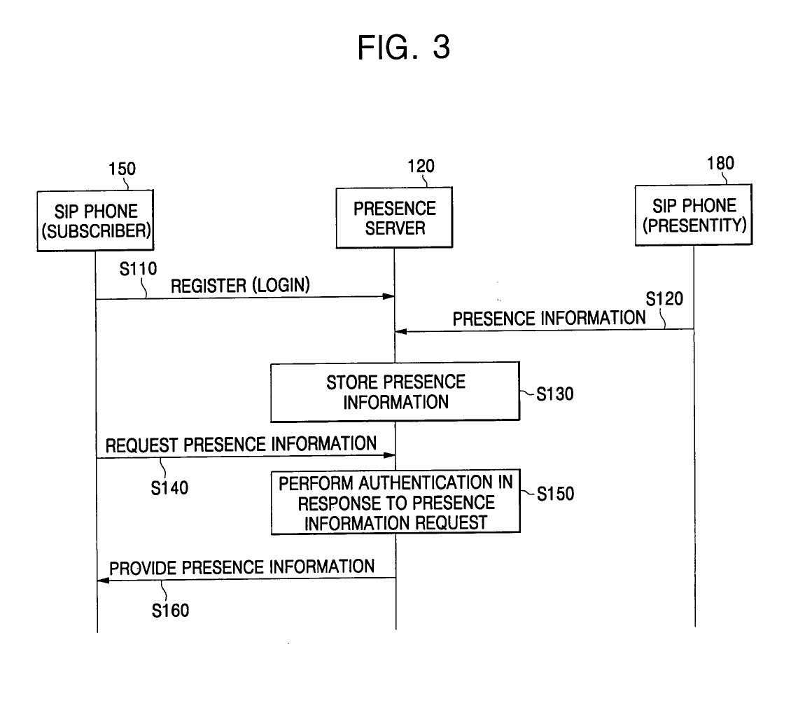

FIG. 3 is a diagram of a presence service providing method. FIG. 3 shows that the presence server 120 provides the SIP phone 150 with the presence information of the SIP phone 180 in response to a request from the SIP phone 150 in the communication system of FIG. 2. In this regard, the SIP phone 150 is a subscriber, and the SIP phone 180 serves as the presentity which provides the SIP phone 150 with the presence information.

Further referring to FIG. 3, the SIP phone 150 registers with the presence server 120 (e.g., logs in) (S110), and then requests the presence information from the presence server 120 in order to obtain status information of the SIP phone 180 (S140). The presence server 120, which receives and stores the presence information from the SIP phone 180 (S120 and S130), performs authentication in response to the presence information request (S150). The presence server 120 provides the presence information of the SIP phone 180 to the SIP phone 150 if the presence information request is approved (S160).

In FIG. 3, steps S120 and S130 relating to storage of the presence information of the SIP phone 180 in the presence server 120 are performed between steps S110 and S140. However, steps S120 and S130 are performed regardless of operation between the SIP phone 150 and the presence server 120. That is, the SIP phone 180 forwards its presence information to the presence server 120 regardless of whether or not the SIP phone 150 requests it.

An Internet engineering task force (IETF) SIP for instant messaging and presence leveraging extensions (SIMPLE) working group (WG) usually uses a SUBSCRIBE method, a NOTIFY method, and a PUBLISH method, which were produced in 2001, and which are defined in RFC3265, in order to provide instant messaging and presence service models defined by the instant messaging and presence protocol working group (IMPPWG) through SIP which is being used in various fields. The SUBSCRIBE method is used by one subscriber to request online accessibility information of the other subscriber (presentity), the NOTIFY method is used by the presence system to inform the subscriber to SUBSCRIBE for online status information of the presentity, and the PUBLISH method is used to publish the presence information to a presence agent.

Thus, in FIG. 3, the registration step S110 of the SIP phone 150 uses the SUBSCRIBE method, the step S120 of forwarding the presence information of the SIP phone 180 uses the PUBLISH method, and the presence information providing step S160 of the presence server 120 uses the NOTIFY method.

However, the SIP presence technology described above has not yet been applied to network operation and management.

For example, in the communication system of FIG. 2, the call manager 110 and the routers 130 and 160 may require supplemental information (e.g., interface information) in addition to information for call processing. In this case, another information transmitting method, rather than the SIP protocol for call processing, should be used. That is, the SIP protocol cannot be used to transmit supplemental information between network components of the communication system, and thus a separate protocol for transmitting the supplemental information is needed.

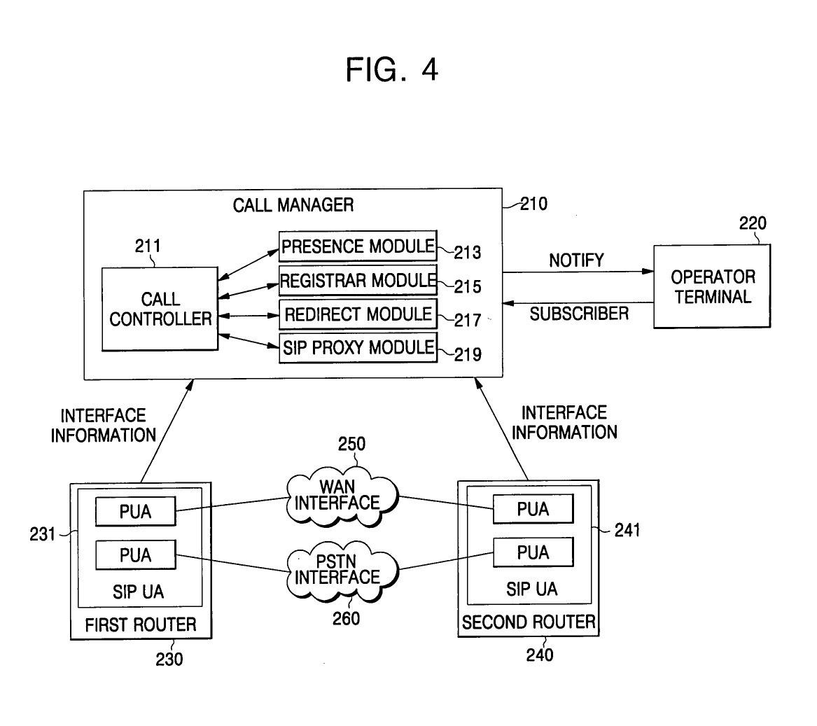

FIG. 4 is a block diagram of a communication system according to an embodiment of the present invention. The communication system of FIG. 4 includes a presence module 213 within the call manager 210 for providing a presence function, presence user agents (PUAs) within the SIP user agents (SIP UAs) 231 and 241 of each of the network components (e.g., first and second routers 230 and 240) for forwarding information on interface connecting network components, and an operator terminal 220 which receives, in real time, the interface information on the network components from the presence module 213.

In the latter regard, the call manager 210 preferably includes a call controller 211, a registrar module 215, a redirect module 217, and an SIP proxy module 219 for supporting the typical SIP function.

In providing the interface information on the network components to the operator terminal 220 which registers with the presence module 213, the presence module 213 preferably performs information exchange between the presence module 213 and the operator terminal 220, and between the presence module 213 and the network components 230 and 240, using the SUBSCRIBE method and the NOTIFY method which are defined in RFC3265, and the PUBLISH method defined in RFC3903.

That is, the operator terminal 220 uses the SUBSCRIBE method to register with the presence module 213, the network components 230 and 240 use the PUBLISH method to provide the interface information to the presence module 213, and the presence module 213 uses the NOTIFY method to forward the interface information on the network components 230 and 240 to the operator terminal 220. Preferably, the presence module 213 forwards corresponding interface information on the network components at the request of the operator terminal 220.

The operator terminal 220 may provide users with corresponding interface information in text form in response to a text-type interface information request. Preferably, the operator terminal 220 includes a graphic user interface (GUI) as a module for outputting the interface information in response to the interface information request.

The operator terminal 220 may be a personal computer (PC), a personal digital assistant (PDA), a portable phone, or a portable computer.

The presence module 213 also has an interface switching function, in addition to the function of providing the interface information transmitted from the network components 230 and 240 to the operator terminal 220. For example, if the respective network components or routers 230 and 240 have a plurality of PUAs and are connected to a plurality of networks, such as a wide area network (WAN) interface 250 and a PSTN interface 260, and a certain interface corresponding to one of the plurality of networks presents an obstacle, the presence module 213 detours around or circumvents the interface generating the obstacle and performs communication. If the interfaces of the first and second routers 230 and 240 connected to the WAN interface 250 are disabled, the presence module 213 performs interface switching so as to connect the first and second routers 230 and 240, respectively. That is, an automatic rerouting function is performed so that a call is connected through the PSTN interface 260, which is an alternative interface.

The presence module 213 operates under the control of the call controller 211.

Preferably, the first and second routers 230 and 240, respectively, and the presence module 213 exchange information using the SIP protocol.

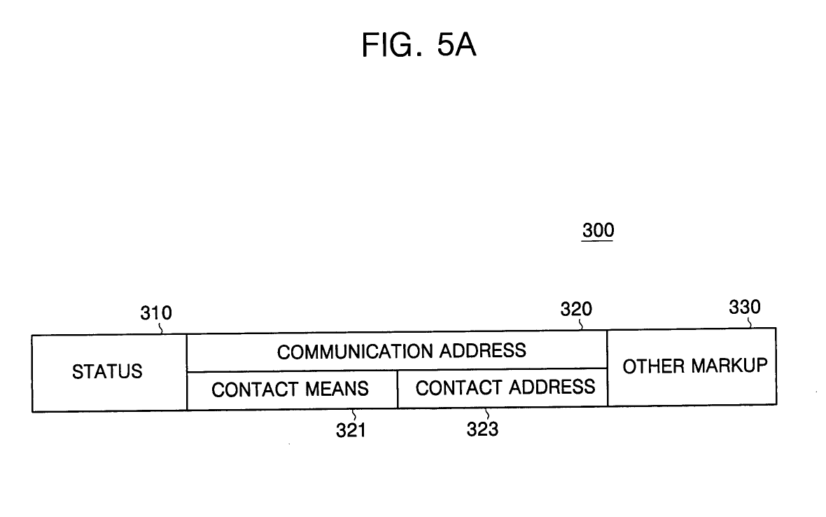

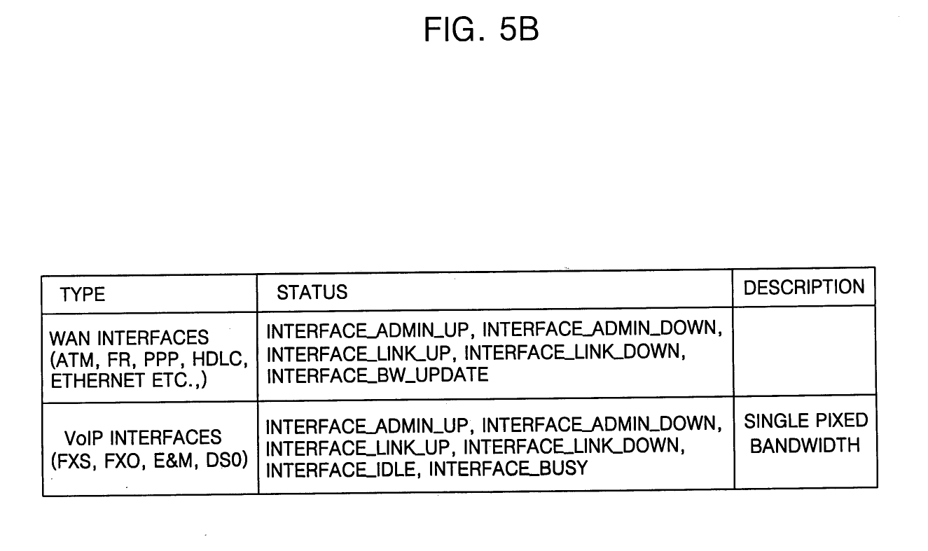

FIGS. 5A and 5B show an example of the interface information according to the present invention.

FIG. 5A shows interface information 300 which is transmitted from the first and second routers 230 and 240, respectively, to the presence module 213. Further referring to FIG. 5A, the interface information 300 includes a status field 310, a communication address field 320, and another markup field 330. The communication address field 320 includes a contact means 321 and a contact address 323.

The status field 310 stores status information according to the type of a corresponding interface, and the communication address field 320 stores address information of the corresponding interface.

FIG. 5B shows the status information stored in the status field 310 of the interface information 300 of FIG. 5A. Referring to FIG. 5B, the status field 310 stores the status information according to the interface type. If the interface type is a WAN interface (e.g., ATM, FR, PPP, HDLC, Ethernet, etc.), the status information includes INTERFACE_ADMIN_UP (for the situation wherein the interface is connected by an operator), INTERFACE_ADMIN_DOWN (for the situation wherein an interface is shut down by an operator), INTERFACE_LINK_{—UP} (for the situation wherein a physical link is connected), INTERFACE_LINK_DOWN (for the situation wherein a physical link is shut down), and INTERFACE_BW_UPDATE (bandwidth update information). If the interface type is a VoIP interface (e.g., FXS, FX0, E&M, DS0, etc.), the status information includes INTERFACE_ADMIN_UP (for the situation wherein an interface is connected by an operator), INTERFACE_ADMIN_DOWN (for the situation wherein an interface is shut down by an operator), INTERFACE_LINK_UP (for the situation wherein a physical link is connected), INTERFACE_LINK_DOWN (for the situation wherein a physical link is shut down), INTERFACE_IDLE (for the situation wherein an interface is connected but is not yet in service), and INTERFACE_BUSY (for the situation wherein an interface is connected and is in service).

In the latter regard, the interface information of the respective interfaces is formed as the presence tuple according to the interface type, and is then transmitted all at once in a gateway or VoIP router unit. Then, only the interface information of the interface which changes is transmitted in real time.

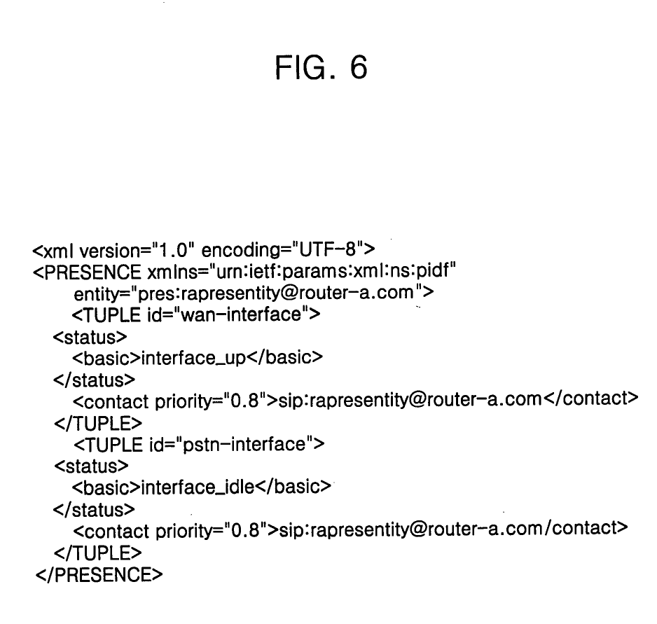

FIG. 6 shows PDIF format information in a PUBLISH method for forwarding the interface information according to an embodiment of the present invention. That is, FIG. 6 shows a message structure in which the interface information is formed as the presence tuple according to the interface type, and then is transmitted all at once.

Referring to FIG. 6, a status of the WAN interface (tuple id=”wan-interface) is “interface_up”, and a status of the PSTN interface (tuple id=”pstn-interface) is “interface_idle”.

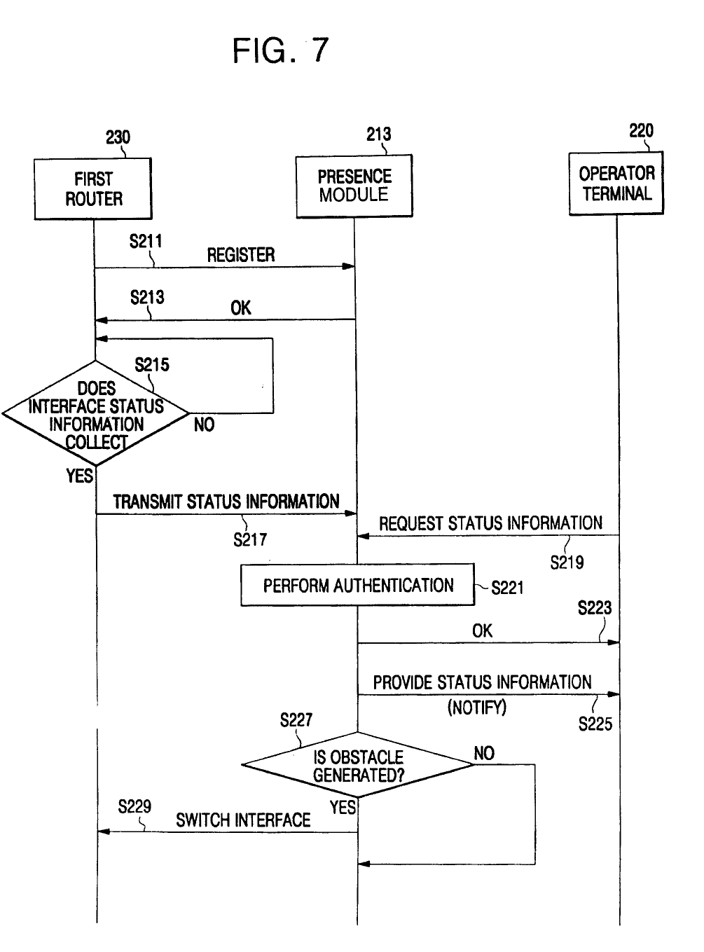

FIG. 7 is a diagram of an interface information providing method according to an embodiment of the present invention. In particular, FIG. 7 shows a case wherein the presence module 213 provides the operator terminal 220 with the interface status information of the first router 230 in the communication system of FIG. 4. The first router 230 already has an interface for interfacing with another network component (e.g., second router 240 of FIG. 4), and receives the interface status information through the interface.

Referring to FIG. 7, the first router 230 should register with the presence module 213 (S211 and S213) in order to transmit its interface status information to the presence module 213. The first router 230 requests the presence module 213 to allow its registration (S211) and receives a response OK from the presence module 213 so as to register with the presence module 213 (S213).

The first router 230 determines whether the interface information (e.g., interface status information) is collected from the interface produced for interfacing with external devices (S215). If the interface information is collected, the first router 230 forwards the status information to the presence module 213 (S217). The presence module 213 stores the status information, and then provides the operator terminal 220 with the status information if a request is received from the operator terminal 220.

Specifically, if a request for the interface status information of the first router 230 is received from the operator terminal 220 (S219), the presence module 213 performs authentication of the interface status information request (S221). If the presence request is approved, the presence module 213 transmits a response message OK to the operator terminal 220 (S223) and then provides the interface status information of the first router 230 to the first router 220 (S225).

As described above, the presence module 213 performs the interface switching function in addition to the interface status information providing function. For the sake of this function, the presence module 213 analyzes the interface status information transmitted in step S217 to determine whether the corresponding interface is disabled, that is, whether an obstacle is generated (S227). If it is determined that the interface of the first router 230 is disabled, the interface is switched (S229). For example, in the case where the first router 230 is connected to a plurality of networks, if a certain interface connected to one network is disabled, the interface connected to the one network is switched to an interface connected to other networks. In FIG. 4, if the WAN interface 250 of the first and second routers 230 and 240 is disabled, interface switching is performed to connect the first and second routers 230 and 240, respectively, through the PSTN interface 260.

The devices (e.g., the first router 230, the presence module 213, and the operator terminal 220) exchange interface information preferably using the SUBSCRIBE method and the NOTIFY method which are defined in RFC3265, and the PUBLISH method defined in RFC3903.

That is, the status information transmitting process (S217) of the first router 230 uses the PUBLISH method, the status information request process (S219) of the operator terminal 220 uses the SUBSCRIBE method, and the status information providing process (S225) of the presence module 213 uses the NOTIFY method.

As described above, the communication system of the present invention exchanges the interface information between the network components using the SIP presence function. Thus, the interface status and information can be communicated between the network components using the same SIP protocol as is used for call processing, without the need for a separate protocol. As a result, a disabled interface can be dealt with faster, and a greater variety of additional services can be implemented.

Although preferred embodiments of the present invention have been described in detail, it will be appreciated by those skilled in the art to which the present invention pertains that several modifications and variations can be made without departing from the spirit and scope of the present invention as defined in the appended claims. Accordingly, future variations of the embodiments of the present invention can be covered by the technique of the present invention.

What is claimed is:

1. A communication system, comprising:
a plurality of user agents for collecting interface information on respective network components which form the communication system; and
a call manager including a presence module for providing an online access status and location information of a service user, the call manager receiving the interface information on the respective network components from the user agents through a session initiation protocol (SIP).

2. The system of claim 1, further comprising a terminal for outputting the interface information on the respective network components in response to a request from a user, wherein the call manager transmits the interface information to the terminal in real time.

3. The system of claim 2, wherein an information exchange among the user agents, the terminal and the call manager is performed using at least one of a SUBSCRIBE method and a NOTIFY method, which are defined in RFC3265, and a PUBLISH method defined in RFC3903.

4. The system of claim 3, wherein the terminal transmits a request to the call manager for interface information of a certain network component using the SUBSCRIBE method.

5. The system of claim 4, wherein the terminal includes a user interface module for outputting interface information transmitted in response to an interface information request.

6. The system of claim 3, wherein the call manager provides the terminal with the interface information of a certain network component using the NOTIFY method.

7. The system of claim 3, wherein the user agents provide the presence module with the interface information on the respective network components using the PUBLISH method.

8. The system of claim 2, wherein the interface information includes a status field for storing status information according to a type of corresponding interfaces and an address field for storing address information of the corresponding interfaces.

9. The system of claim 1, wherein when any part of the interface information on the respective network components collected by the user agents contains an obstacle, a corresponding interface which generated the obstacle is circumvented and connection is performed between network components with no obstacles.

10. A method of providing information on an interface connecting network components in a communication system, comprising the steps of:
collecting, by means of agent modules corresponding to the network components, interface information on the network components;
converting the interface information into a predetermined format; and
transmitting, by means of each of the agent modules, the interface information converted into the predetermined format to a call manager of the communication system using a session initiation protocol (SIP).

11. The method of claim 10, further comprising the steps of:
storing, by means of the call manager, the interface information; and
providing, by means of the call manager, corresponding interface information in response to an interface information request.

12. The method of claim 11, further comprising the steps of, when any of the collected interface information contains an obstacle, detouring around the interface that generated the obstacle and connecting another interface such that the network components are connected with no obstacles.

13. The method of claim 11, further comprising the step of performing, by means of the call manager, authentication of the interface information request.

14. The method of claim 11, wherein the step of transmitting the interface information is performed using a PUBLISH method defined in RFC3903.

15. The method of claim 11, wherein the interface information request is performed using a SUBSCRIBE method defined in RFC3265.

16. The method of claim 11, wherein the step of providing the corresponding interface information is performed using a NOTIFY method defined in RFC3265.

17. The method of claim 10, wherein the interface information includes a status field for storing status information according to a type of a corresponding interface, and an address field for storing address information of the corresponding interface.

18. The method of claim 10, wherein the step of transmitting the interface information is performed using a PUBLISH method defined in RFC3903.
